(19) United States
(12) Patent Application Publication
(10) Pub. No.: US 2006/0070674 A1
(43) Pub. Date: Apr. 6, 2006

(54) Substrate with offset flow passage

(76) Inventor: Paul G. Eidsmore, Santa Cruz, CA (US)

Correspondence Address: CALFEE HALTER & GRISWOLD, LLP, 800 SUPERIOR AVENUE, SUITE 1400, CLEVELAND, OH, 44114, US

(21) Appl. No.: 11/242,312

(22) Filed: Oct. 3, 2005

Related U.S. Application Data
(60) Provisional application No. 60/615,315, filed on Oct. 1, 2004.

(51) Int. Cl. F16K 27/00

(52) U.S. Cl. 137/884

(57) ABSTRACT

Substrates for modular fluid flow systems that include a secondary flow aperture or passage that is offset from a process flow path. The secondary flow aperture or passage provides a second flow path to a flow control device to allow secondary functions, such as purging, to be performed by the flow control device.

### RELATED APPLICATIONS

This non-provisional application claims the benefit of U.S. Provisional Patent Application 60/615,315, entitled “Substrate with Integrated Purge,” filed Oct. 1, 2004, which is hereby incorporated in its entirety.

### TECHNICAL FIELD OF THE INVENTION

The invention relates generally to modular fluid flow systems of the type that generally use surface mounted components on a substrate. More particularly, the invention is related to a substrate that includes a secondary flow passage that is offset from a process flow path.

### BACKGROUND OF THE INVENTION

Modular fluid flow systems commonly use a substrate arrangement that provides a flow path for a process fluid such as gas. A plurality of flow control devices are in fluid communication with the process flow path and may include such devices as valves, mass flow meters, check valves and so on. Whenever it is necessary to purge the flow path, a purge valve or flow control device must be in fluid communication with the flow path. However, the architecture of known substrate systems do not lend themselves to easily allow a purge function to be accommodated because the purge function requires a separate flow path to the point of entry. This necessitates special substrate configurations or advance decisions on where to locate the purge function, either of which reduces the benefits of the modular concept.

### SUMMARY OF INVENTION

The present application relates to a substrate for modular flow systems that includes a secondary flow aperture and/or passage that is offset from a process flow path. The offset aperture and/or passage allows for fluid allows for fluid communication with a secondary port, such as a purge port, of a flow control device without interfering with or modifying a series of inlet and outlet apertures in the substrate that are associated with the process flow path.

One embodiment of a substrate for a modular fluid flow system is adapted to support one or more surface mount components thereon. A plurality of in-line inlet and outlet apertures are defined in the substrate. A plurality of flow passages are defined in the main body that interconnect pairs of the in-line inlet and outlet passages. An offset aperture is defined in the main body. The offset aperture is positioned laterally with respect to the plurality of in-line inlet and outlet apertures. An offset passage may be defined in the main body in fluid communication with the offset aperture. The offset passage is offset with respect to the respect to the flow passages.

One embodiment of a fluid flow system includes a fluid flow device, such as a purge valve, assembled with a substrate such that in-line inlet and outlet ports and an offset port of the fluid flow device are in alignment with in-line inlet and outlet apertures and an offset aperture of the substrate.

In one embodiment, the ports of a fluid flow device do not align with apertures in a substrate. For example, in-line inlet, outlet and purge ports of a fluid flow device do not align with the apertures of a substrate that includes an offset aperture. In this embodiment, fluid flow is routed between one of the three inline ports and the substrate offset aperture. Fluid flow is first directed through the substrate aperture along a first flow path portion defined by the substrate aperture. Then fluid flow is directed along a second flow path portion that is generally transverse to the first flow path portion from the substrate aperture toward the appropriate in-line ports. Then fluid flow is along a third flow path portion that is generally transverse to the second flow path portion to the appropriate in-line ports.

One arrangement for routing fluid flow between a substrate aperture that is offset with respect to a fluid flow device port includes an adapter member positioned between the substrate and the flow control device. The adapter member includes apertures that provide fluid communication between the inlet port and a first of the in-line apertures, fluid communication between the outlet port and a second of the in-line apertures, and fluid communication between the offset port and the first offset aperture.

Although the invention is described herein in the exemplary embodiments as being used in a fluid flow system that includes a substrate and one or more surface mount components, such description is intended to be exemplary in nature and should not be construed in a limiting sense. The invention may be used with any arrangement in which it is desired to establish a secondary flow aperture and/or passage that is offset from a process flow path.

### DESCRIPTION OF THE DRAWINGS

FIG. 1 is a perspective view of a fluid flow system including a flow control device with an offset port and a flow block;

FIG. 2 is a side view of a fluid flow system including a flow control device with an offset port and a flow block;

FIG. 3 is a cross-sectional view taken along the plane indicated by lines 3-3 in FIG. 4;

FIG. 4 is a top view of a fluid flow system including a flow control device with an offset port and a flow block;

FIG. 5 is a front view of a fluid flow system including a flow control device with an offset port and a flow block;

FIG. 6 is a cross-sectional view taken along the plane indicated by lines 6-6 in FIG. 4;

FIG. 7 is an exploded view of a fluid flow system including a flow control device with an offset port and a flow block;

FIG. 8 is an exploded view of a fluid flow system including a flow control device with an offset port and a flow block;

FIG. 9 is a perspective view of a fluid flow system including a flow control device with an offset port, a flow plate, and a substrate;

FIG. 10 is a side view of a fluid flow system including a flow control device with an offset port, a flow plate, and a substrate;

FIG. 11 is a cross-sectional view taken along the plane indicated by lines 11-11 in FIG. 12;

FIG. 12 is a top view of a fluid flow system including a flow control device with an offset port, a flow plate, and a substrate;

FIG. 13 is a front view of a fluid flow system including a flow control device with an offset port, a flow plate, and a substrate;

FIG. 14 is a cross-sectional view taken along the plane indicated by lines 14-14 in FIG. 12;

FIG. 15 is an exploded view of a fluid flow system including a flow control device with an offset port, a flow plate, and a substrate;

FIG. 16 is an exploded view of a fluid flow system including a flow control device with an offset port, a flow plate, and a substrate;

FIG. 17 is an exploded view of a fluid flow system including a flow control device with an offset port, a flow plate, and a substrate;

FIG. 18 is a perspective view of a fluid flow system including a flow control device with an offset port and a flow plate;

FIG. 19 is a side view of a fluid flow system including a flow control device with an offset port and a flow plate;

FIG. 20 is a cross-sectional view taken along the plane indicated by lines 20-20 in FIG. 21;

FIG. 21 is a top view of a fluid flow system including a flow control device with an offset port and a flow plate;

FIG. 22 is a front view of a fluid flow system including a flow control device with an offset port and a flow plate;

FIG. 23 is a cross-sectional view taken along the plane indicated by lines 23-23 in FIG. 21;

FIG. 24 is an exploded view of a fluid flow system including a flow control device with an offset port and a flow plate;

FIG. 25 is an exploded view of a fluid flow system including a flow control device with an offset port and a flow plate;

FIG. 26 is a perspective view of a fluid flow system including a flow control device with in-line ports, an adapter plate assembly, and a flow block;

FIG. 27 is a side view of a fluid flow system including a flow control device with in-line ports, an adapter plate assembly, and a flow block;

FIG. 28 is a cross-sectional view taken along the plane indicated by lines 28-28 in FIG. 29;

FIG. 28A is an enlarged view of a portion of FIG. 28;

FIG. 29 is a top view of a fluid flow system including a flow control device with in-line ports, an adapter plate assembly, and a flow block;

FIG. 30 is a side view of a fluid flow system including a flow control device with in-line ports, an adapter plate assembly, and a flow block;

FIG. 31 is a cross-sectional view taken along the plane indicated by lines 31-31 in FIG. 29;

FIG. 31A is an enlarged view of a portion at FIG. 31;

FIG. 32 is an exploded view of a fluid flow system including a flow control device with in-line ports, an adapter plate assembly, and a flow block;

FIG. 33 is an exploded view of a fluid flow system including a flow control device with in-line ports, an adapter plate assembly, and a flow block;

FIG. 34 is a perspective view of a fluid flow system including a flow control device with in-line ports, an adapter plate assembly, and a flow plate;

FIG. 35 is a side view of a fluid flow system including a flow control device with in-line ports, an adapter plate assembly, and a flow plate with multiple channels;

FIG. 36 is a cross-sectional view taken along the plane indicated by lines 36-36 in FIG. 37 of a fluid flow system including a flow control device with in-line ports, an adapter plate assembly, and a flow plate;

FIG. 37 is a top view of a fluid flow system including a flow control device with in-line ports, an adapter plate assembly, and a flow plate;

FIG. 38 is a front view of a fluid flow system including a flow control device with in-line ports, an adapter plate assembly, and a flow plate;

FIG. 39 is a cross-sectional view taken along the plane indicated by lines 39-39 in FIG. 37;

FIG. 40 is an exploded view of a fluid flow system including a flow control device with in-line ports, an adapter plate assembly, and a flow plate;

FIG. 41 is an exploded view of a fluid flow system including a flow control device with in-line ports, an adapter plate assembly, and a flow plate;

FIG. 42 is a perspective view of a fluid flow system including a flow control device with in-line ports, an adapter plate assembly, and a flow block;

FIG. 43 is a side view of a fluid flow system including a flow control device with in-line ports, an adapter plate assembly, and a flow block;

FIG. 44 is a cross-sectional view taken along the plane indicated by lines 44-44 in FIG. 45;

FIG. 45 is a top view of a fluid flow system including a flow control device with in-line ports, an adapter plate assembly, and a flow block;

FIG. 46 is a side view of a fluid flow system including a flow control device with in-line ports, an adapter plate assembly, and a flow block;

FIG. 47 is a cross-sectional view taken along the plane indicated by lines 47-47 in FIG. 45 of a fluid flow system including a flow control device with in-line ports, an adapter plate assembly, and a flow block;

FIG. 48 is an exploded view of a fluid flow system including a flow control device with in-line ports, an adapter plate assembly, and a flow block;

FIG. 49 is an exploded view of a fluid flow system including a flow control device with in-line ports, an adapter plate assembly, and a flow block;

FIG. 50 is a perspective view of a fluid flow system including a flow control device with in-line ports, an adapter plate assembly, and a flow plate;

FIG. 51 is a side view of a fluid flow system including a flow control device with in-line ports, an adapter plate assembly, and a flow plate;

FIG. 52 is a cross-sectional view as defined by line 52-52 in FIG. 53 of a fluid flow system including a flow control device with in-line ports, an adapter plate assembly, and a flow plate;

FIG. 53 is a top view of a fluid flow system including a flow control device with in-line ports, an adapter plate assembly, and a flow plate;

FIG. 54 is a front view of a fluid flow system including a flow control device with in-line ports, an adapter plate assembly, and a flow plate;

FIG. 55 is a cross-sectional view taken along the plane indicated by lines 55-55 in FIG. 53;

FIG. 56 is an exploded view of a fluid flow system including a flow control device with in-line ports, an adapter plate assembly, and a flow plate;

FIG. 57 is an exploded view of a fluid flow system including a flow control device with in-line ports, an adapter plate assembly, and a flow plate;

FIG. 58 is a perspective view of a fluid flow system including a flow control device with an offset port and a flow block;

FIG. 59 is a side view of a fluid flow system including a flow control device with an offset port and a flow block;

FIG. 60 is a cross-sectional view taken along the plane indicated by lines 60-60 in FIG. 61;

FIG. 61 is a top view of a fluid flow system including a flow control device with an offset port and a flow block;

FIG. 62 is a front view of a fluid flow system including a flow control device with an offset port and a flow block;

FIG. 63 is a cross-sectional view as defined by line 63-63 in FIG. 61 of a fluid flow system including a flow control device with an offset port and a flow block;

FIG. 64 is an exploded view of a fluid flow system including a flow control device with an offset port and a flow block; and

FIG. 65 is an exploded view of a fluid flow system including a flow control device with an offset port and a flow block.

### DETAILED DESCRIPTION OF EXEMPLARY EMBODIMENTS

The invention contemplates a substrate arrangement concept that allows for the use of a generic substrate with the ability to locate a purge or other desired function at any of a multiple number of desired locations. The substrate includes an offset aperture and/or passage that allows for fluid communication with a secondary port of a fluid flow control device without interfering with or modifying a series of inlet and outlet apertures in the substrate. By generic it is simply meant that the substrate arrangement can accommodate such variations without the need to alter the substrate arrangement itself. In addition to a purge or second flow function, the substrate arrangement has the ability to include other features in the substrate arrangement besides the flow of process fluid. For example, the invention accommodates cooling or heating the substrate arrangement.

The various drawings illustrate different embodiments of the invention. It being understood that each embodiment is generic to its intended use as will be apparent from the following discussion.

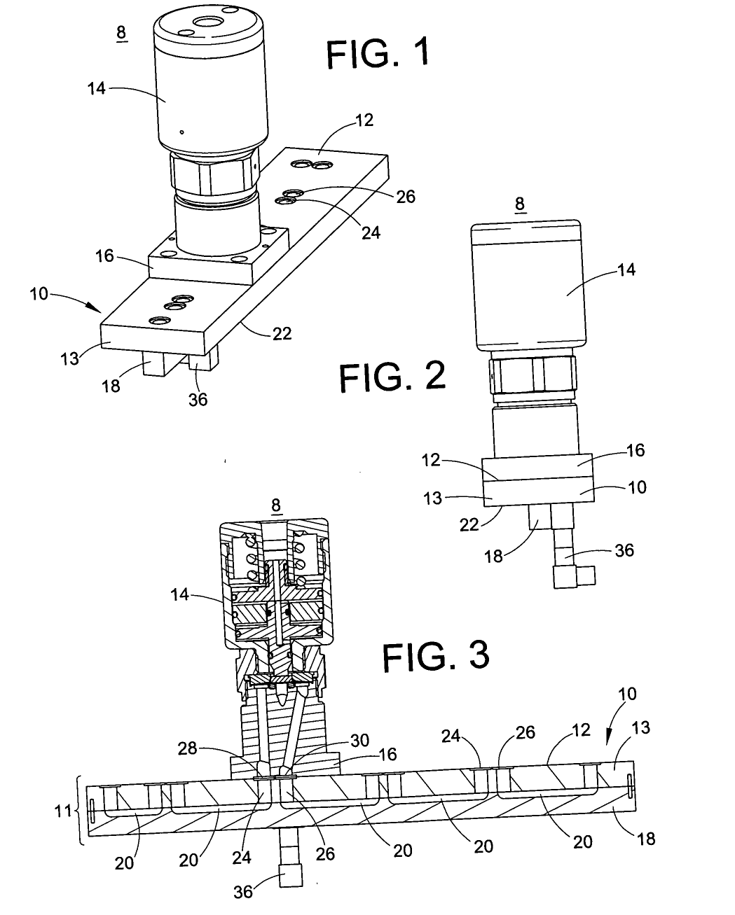

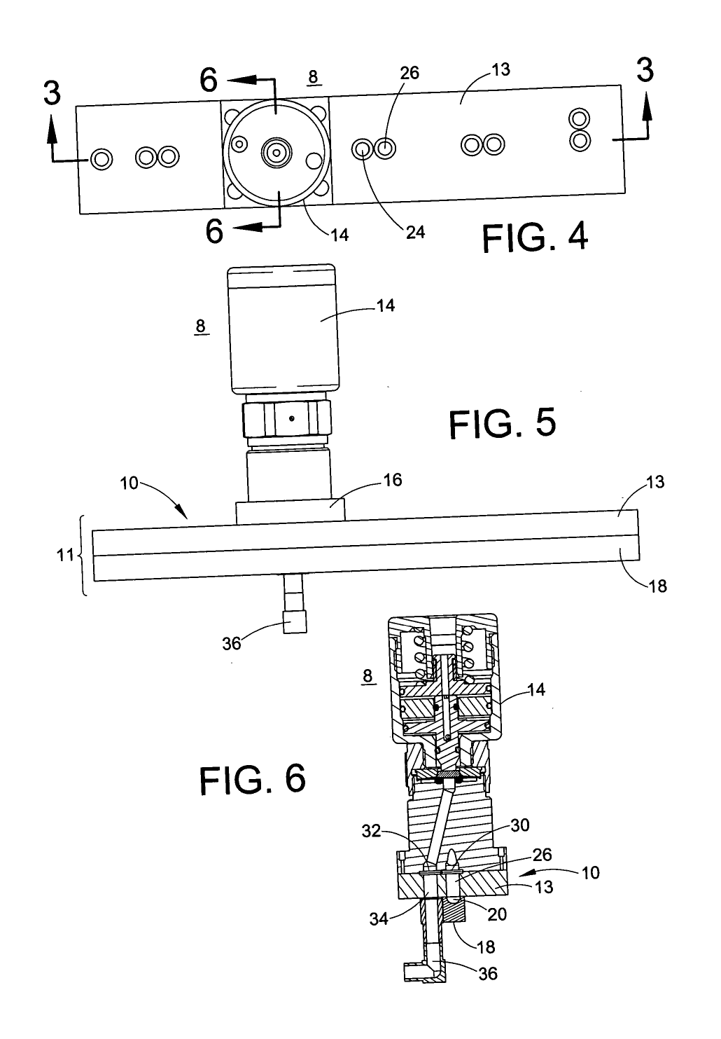

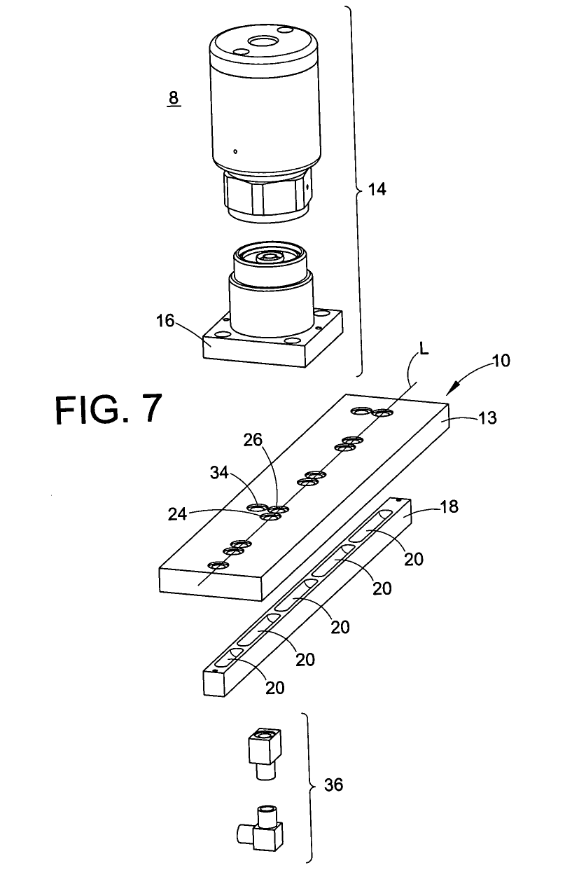

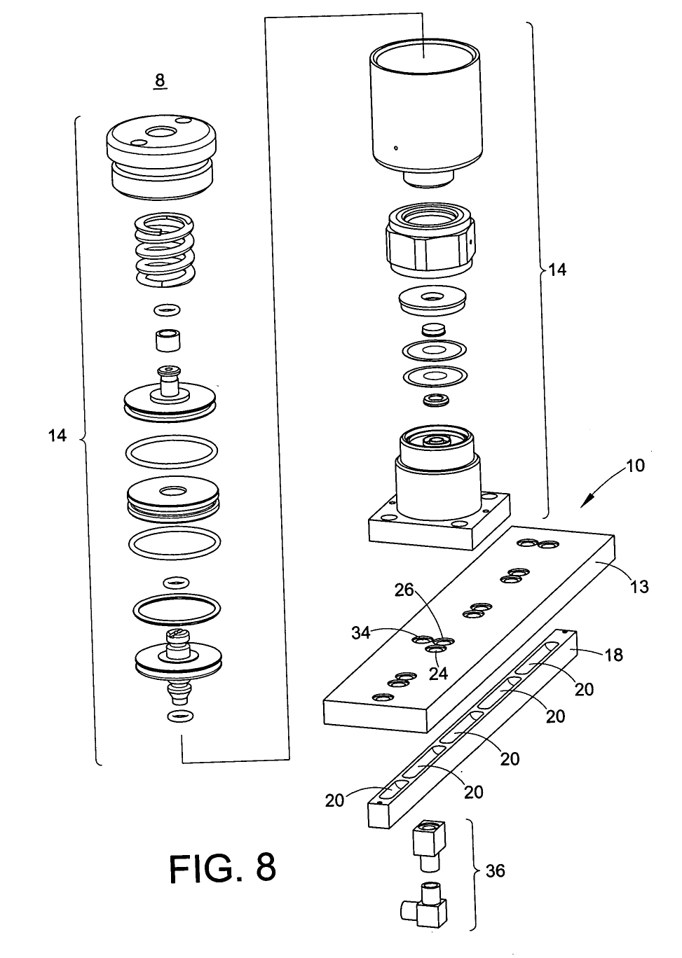

FIGS. 1-8 illustrate a first embodiment of a flow control system 8 that includes a substrate 10 with an offset aperture 34 (see FIG. 7). The substrate 10 has a main body 11 defined by an interface plate 13 and a flow block 18. The substrate 10 has an upper surface 12 on which one or more flow control devices or components 14 are mounted. In all of the embodiments illustrated herein, only one flow control device or component, a purge valve, is illustrated. However, other components can also be mounted on the substrate 10, such as mass flow meters, check valves, and the like. The flow control device 14 includes a mount plate 16 that can be coupled or otherwise affixed to the substrate 10. One typical method of coupling or affixing a flow control device 14 to a substrate 10 is through the use of bolts or other such fasteners. It should be readily apparent that any type of coupling can be used. In the illustrated embodiments, a plurality of inlet and outlet apertures 24, 26 are defined in the main body 11. A plurality of flow passages 20 interconnect pairs of the inlet and outlet apertures. One or more offset apertures 34 are defined in the main body and are positioned laterally with respect to the inlet and outlet apertures 24, 26.

The flow block 18 is coupled, joined or otherwise affixed to the interface plate 13 to form the substrate 10. The flow block 18 defines a plurality of fluid or flow paths 20 (see FIG. 3) that are interconnected as needed by operation of flow control devices 14. In the embodiment illustrated by FIGS. 1-8 the flow block 18 is stick shaped and has a width that is less than the width of the interface plate 13. When this flow block 18 is coupled to the interface plate 13 a substantial portion of a lower surface 22 of the interface plate 13 remains exposed. The flow block is long enough to accommodate the plurality of flow paths 20.

The interface plate defines a series of inlet apertures 24 and outlet apertures 26 the are typically in fluid communication with the flow paths 20 when the flow block 18 is coupled to the substrate 10. These apertures 24, 26 are typically, although need not be, formed in a standard configuration in terms of their spacing and seal arrangements so that different flow control devices 14 can be interchangeably mounted in the same location. The series of inlet and outlet apertures 24, 26 are typically positioned in an in-line arrangement. This is to say that when the series of apertures 24, 26 is arranged, the apertures 24, 26 can be bisected along a diameter of the apertures 24, 26 by a common line or axis L, as shown in FIG. 7. This arrangement allows multiple flow control devices 14 to be coupled or mounted to the substrate 10 such that the devices 14 are interconnected or in fluid communication with the flow paths 20. It should be understood that the terms inlet and outlet apertures 24, 26 are for reference only and are interchangeable. By either rotating the flow control device 14 or by reversing the flow in the device 14 or system, an inlet aperture 24 can serve as an outlet aperture and an outlet aperture 26 can serve as an inlet aperture.

Although the substrate 10 has been described and shown as two components, it is to be understood that the substrate 10 may be formed as one component by any suitable process such as molding or casting. If the interface plate 13 and flow block 18 are made as separate components, they may be coupled or otherwise affixed together to form the substrate 10 by any standard coupling method, for example coupling with standard fasteners or diffusion bonding.

As best illustrated in FIGS. 3 and 6, the illustrated purge valve 14 includes a process inlet port 28 and a process outlet port 30. The inlet and outlet ports 28, 30 can be placed in fluid communication with aligned inlet and outlet apertures 24, 26 when the valve 14 is mounted or otherwise coupled to the substrate 10. As best illustrated in FIG. 6, the valve 14 also includes an third or offset port 32. An example of such a valve is described in U.S. patent application Publication No. 2005/0005981, to Eidsmore et al., entitled “Modular Fluid Components and Assembly,” published Jan. 13, 2005 and is incorporated herein by reference in its entirety. In the embodiment illustrated by FIGS. 1-8 the offset port 32 is used for purge inlet, but can be used for other functions if so desired. The offset aperture 34 of the substrate accommodates the offset port 32. As is best illustrated in FIG. 7, the offset aperture 34 may be positioned laterally with respect to the common line or axis L bisecting the inlet and outlet apertures 24, 26.

When the purge valve 14 is mounted to the substrate such that the inlet and outlet ports 28, 30 are connected to and placed in fluid communication with the inlet and outlet apertures 24, 26, the offset port 32 is also connected to and placed in fluid communication with the offset aperture 34. A purge inlet fitting 36 or any other connector 36 can be coupled to the substrate 10. In the illustrated example, the connector is connected to and is in fluid communication with the offset port 32.

The offset aperture 34 can be formed in the substrate 10 at the time of manufacture. However, a generic substrate 10, without a preformed offset aperture 34, can be easily adapted to accommodate a purge function anywhere along the substrate 10 by drilling a hole 34 through the substrate 10 at a location where the offset port 32 contacts the substrate when the purge valve 14 is coupled to the substrate 10. In another embodiment, an offset aperture may be provided for each pair of inlet and outlet apertures 24, 26 or a subset of a subset of the inlet and outlet apertures at the time of manufacture.

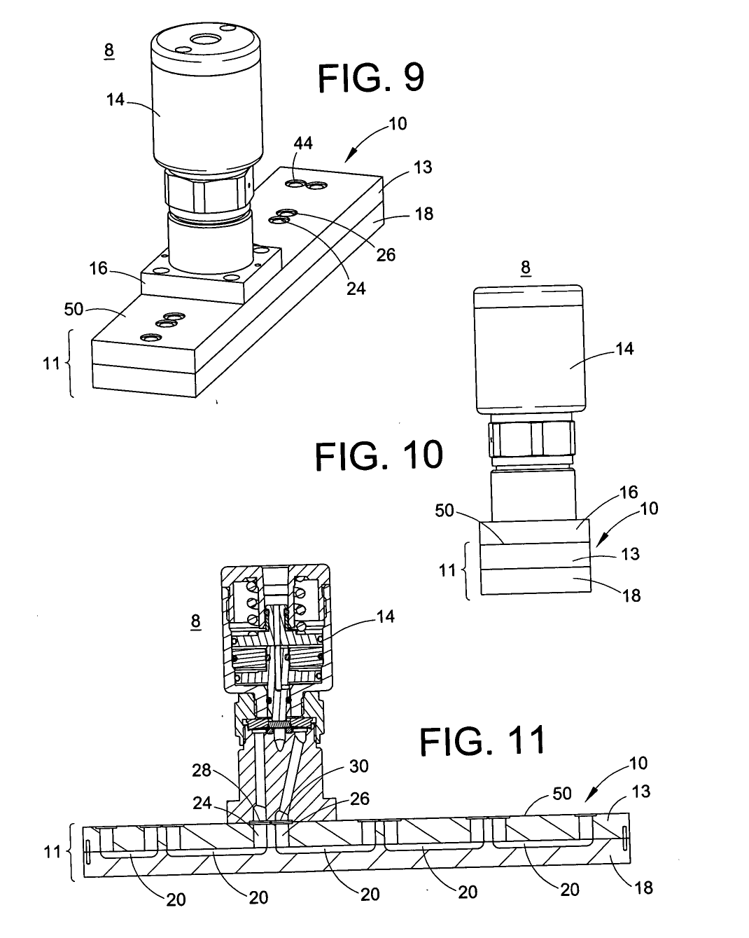

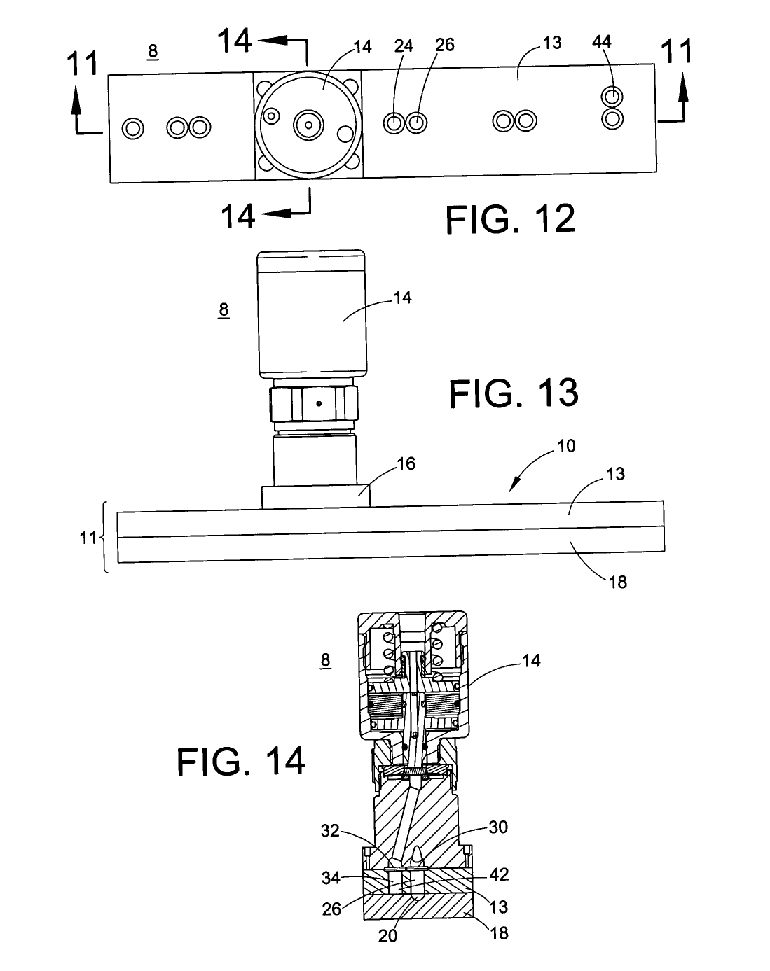

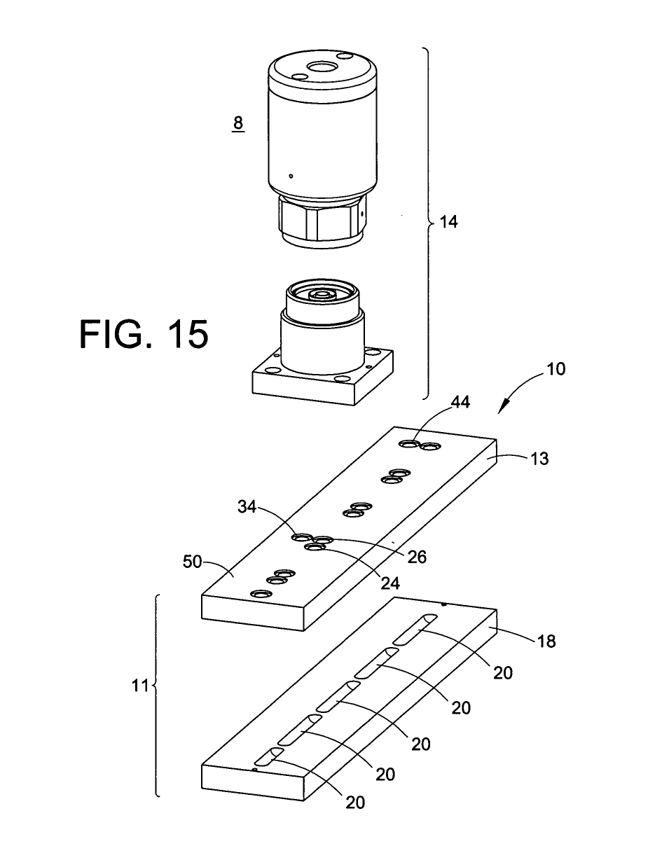

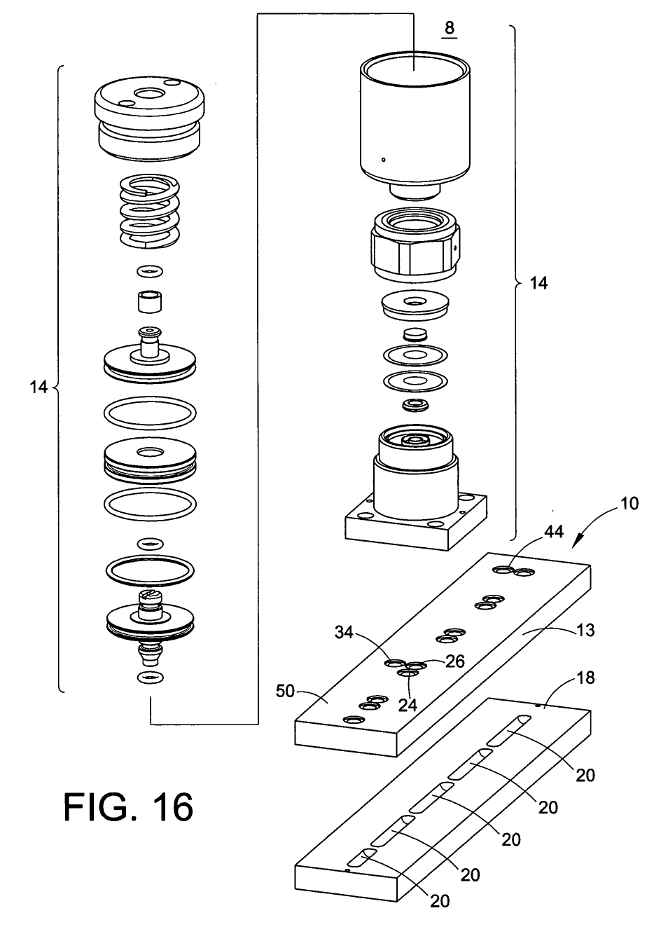

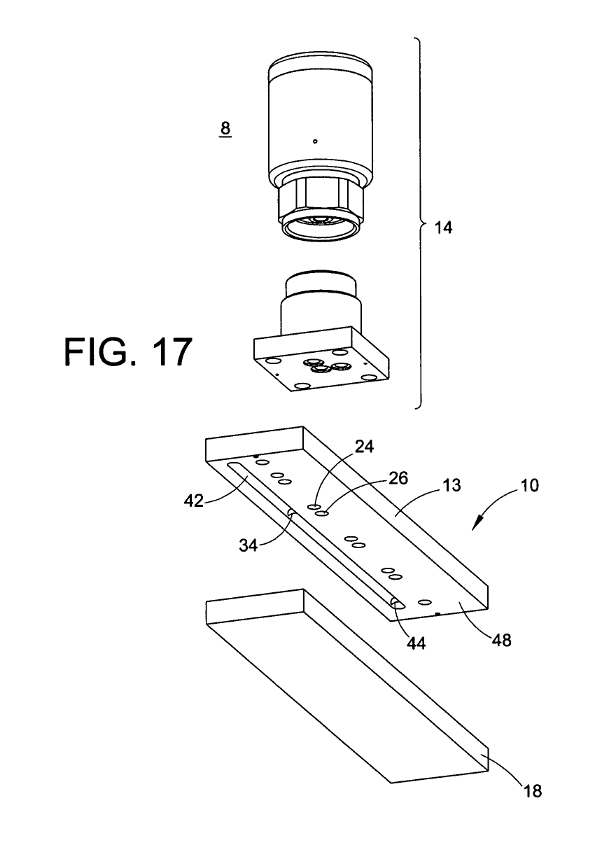

FIGS. 9-17 illustrate another embodiment of a substrate 10 for a fluid flow system 8. In this embodiment, the substrate 10, in addition to defining a plurality of inlet and outlet apertures 24, 26 and an offset aperture 34, also defines an offset channel or passage 42 (as best illustrated in FIG. 17) that is in fluid communication with the offset aperture 34. The substrate may also optionally define additional offset apertures, such as the illustrated second offset aperture 44 in fluid communication with the channel 42. In addition, the flow block 18 is wide enough to include the channel 42. In the example illustrated by FIGS. 9-17, the flow block 18 is approximately as wide as the interface plate 13 and when the flow block 18 is coupled to the interface plate a lower surface 48 of the interface plate is generally not exposed.

Similar to the first embodiment, the flow block 18 can be made as a separate component and coupled or affixed to the interface plate 13 to form the substrate through any method, including diffusion bonding. In addition, the substrate 10 can be made as an integral piece at the time of manufacture by any suitable process such as molding or casting. In the illustrated embodiment, the channel 42 is shown as being formed in the interface plate 13 and exposed on the lower surface 48. The channel is enclosed on this exposed side when the flow block 18 is coupled to the interface plate 13. Alternatively, when the interface plate and the flow block 18 are formed as one component during manufacture, the channel 42 may be formed entirely in the interface plate 13 or may be formed partially in the interface plate and partially in the flow block 18.

Similar to the first embodiment illustrated in FIGS. 1-8, in the embodiment illustrated by FIGS. 9-17, flow control devices 14 are mountable on an upper surface 50 of the substrate 10 such that the inlet and outlet ports 28, 30 are in fluid communication with inlet and outlet apertures 24, 26 located in the substrate 10. The offset port 32 is in fluid communication with the offset aperture 34, which in turn places the offset port 32 in fluid communication with the channel 42. The flow block 18 includes a plurality of flow paths 20 as in the first embodiment, which are in fluid communication with the inlet and outlet ports 28, 30 via the inlet and outlet apertures 24, 26. The second offset aperture 44 may serve as a purge inlet for connection to a purge line (not shown). Additional apertures 34 may be added to allow a purge valve to be mounted at a variety of different locations.

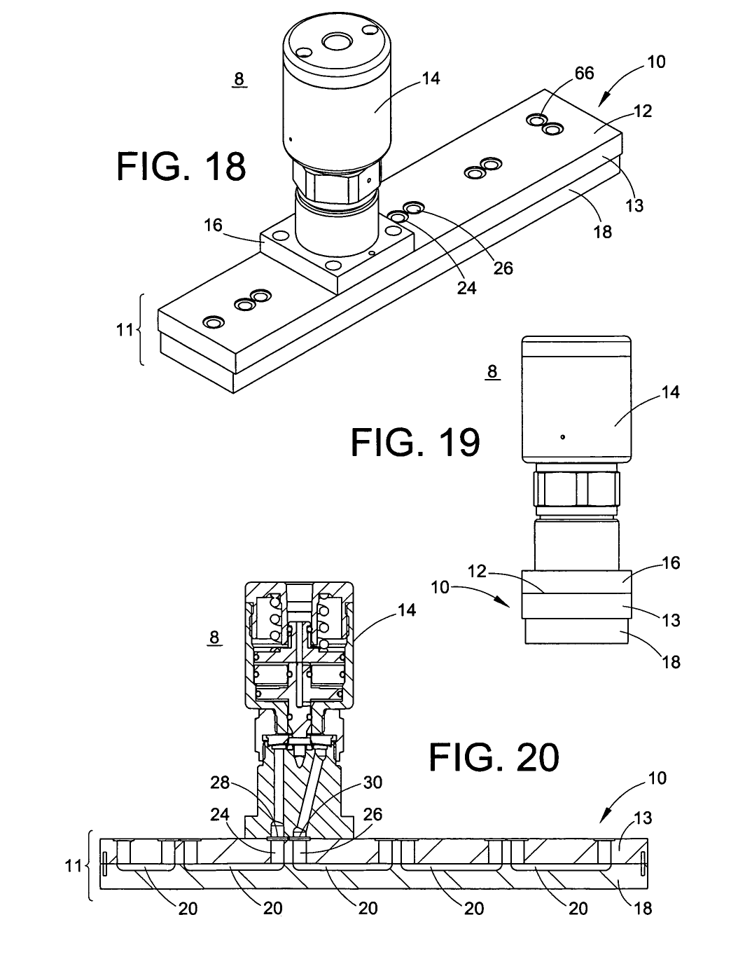

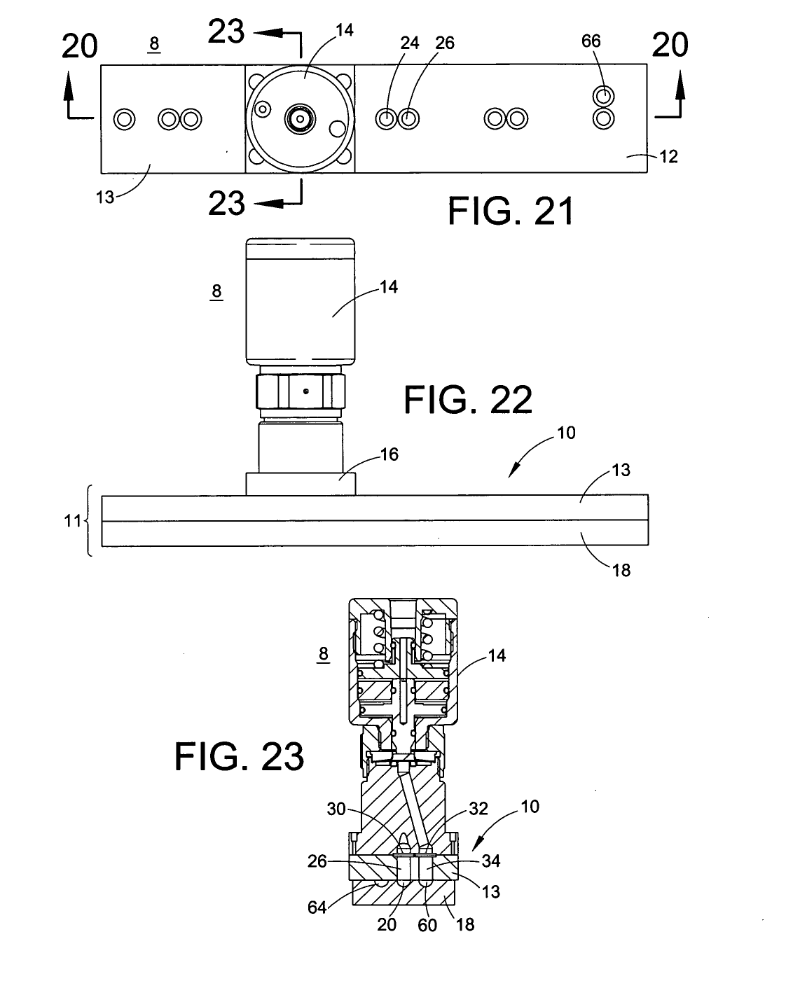

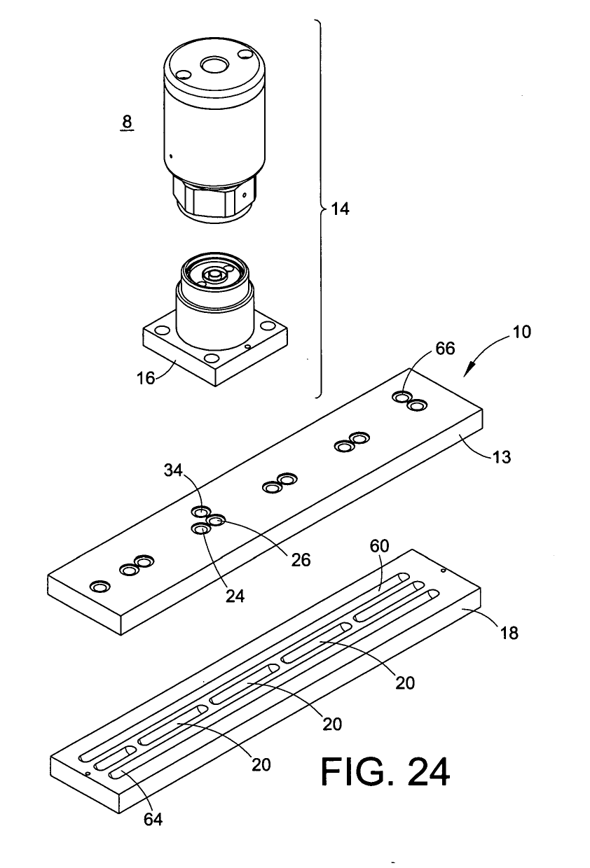

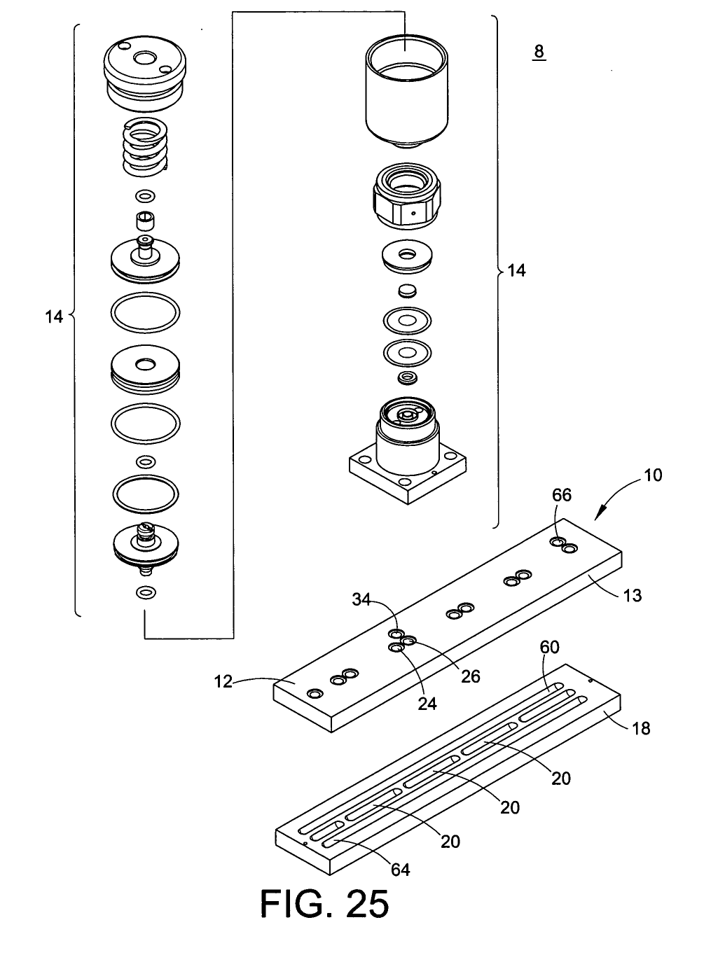

FIGS. 18-25 illustrate another example of a flow control system that is similar to the embodiment shown in FIGS. 9-17. One distinction is that an offset channel or passage 60 is formed in the flow block 18, as opposed to the interface plate 13. The interface plate 13 used in this embodiment may be the interface plate 13 described in the first embodiment and illustrated in FIGS. 1-8. An optional second channel 64 can also be formed in the flow block 18 to add flexibility to the system. For instance, this allows the flow block 18 to be used for multiple purposes. For example, a purging flow paths 20 may be defined by the first channel 60 and a heating or cooling the flow block may be defined by the second channel 64. The first channel 60 may be accessed by the offset port 32 though the first offset aperture 34. This channel 60 may also be accessed by a second offset aperture 66, which can serve as a purge inlet. The second channel 64 may be accesses by similar apertures (not shown) formed in the substrate 10.

In the embodiments previously discussed, flow paths 20 have been described as being formed in a flow block 18. Any component that contains a flow path or a series of flow paths, as described herein, can generally be referred to as a flow block.

In one embodiment of a flow control system 8, a port 32 of a flow control device is axially offset with respect to an offset aperture 34 of a substrate. A number of methods can be used to provide for fluid communication between a port 32 of a flow control device 14 that is axially offset with respect to a substrate aperture 34. In one embodiment, one or more adapter plates 78, 80, 82 are positioned between the substrate 10 and the flow control device. The adapter plate(s) provide fluid communication between the offset substrate aperture and fluid device port. In an exemplary embodiment, fluid flow is routed between one of three in-line ports of a fluid control device and a substrate aperture that is offset with respect to the in-line ports. In the example illustrated by FIGS. 31 and 31A, fluid flow is directed through the substrate aperture 34 along a first flow path portion P₁ defined by the substrate aperture. Fluid flow is then directed along a second flow path portion P₂ that is generally transverse to the first flow path portion P₃. Fluid flow is then directed along a third flow path portion P₃ that is generally transverse to the second flow path portion P₂ and is directed into the in-line purge port. In the illustrated embodiment, the flow path portions P₁ and P₃ are generally parallel and are generally normal to the mounting surface 12. The flow path portion P₂ is generally parallel to the mounting surface 12. It is to be understood that any additional methods that allow for fluid communication with an offset port 32 that does not interfere with a series of inlet and outlet apertures 24, 26 in a substrate is with the scope of this application.

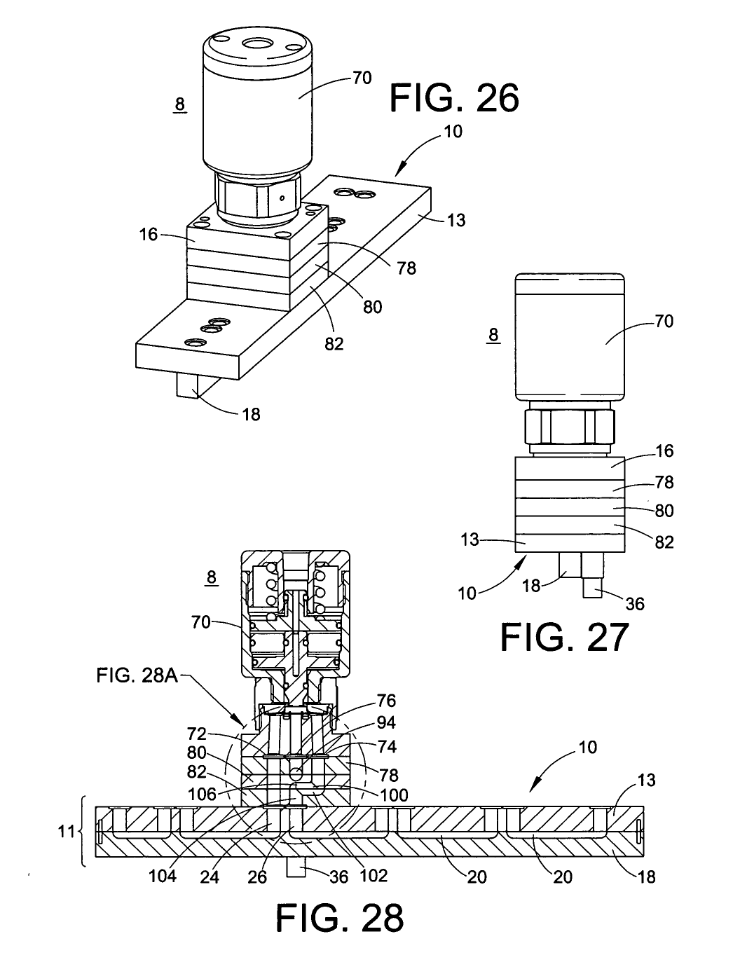

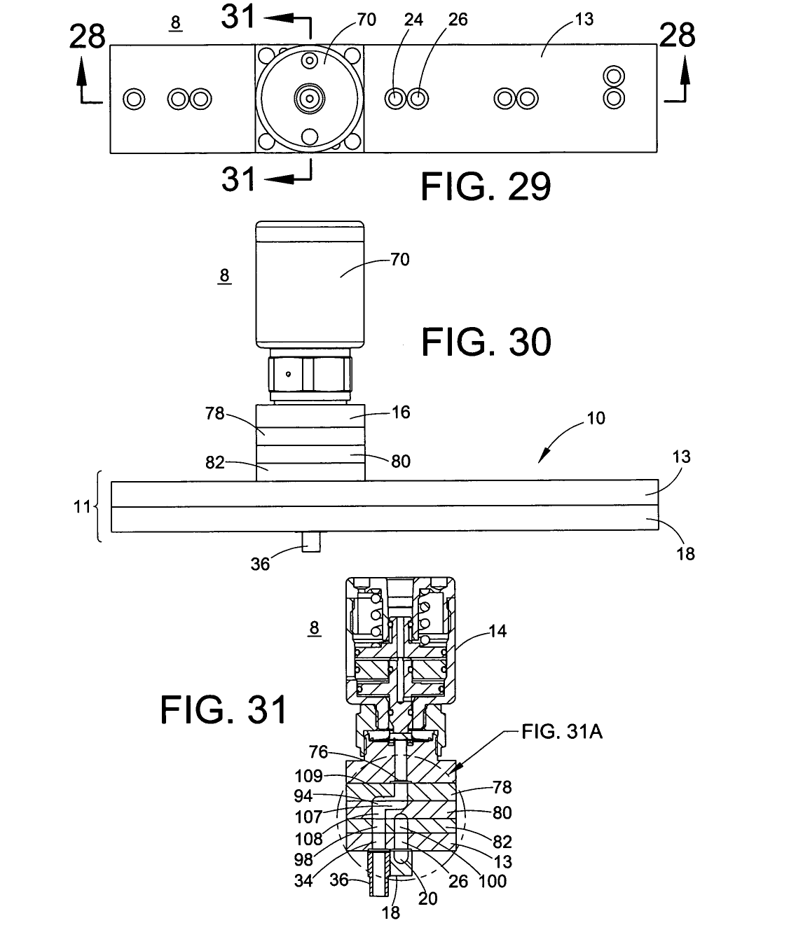

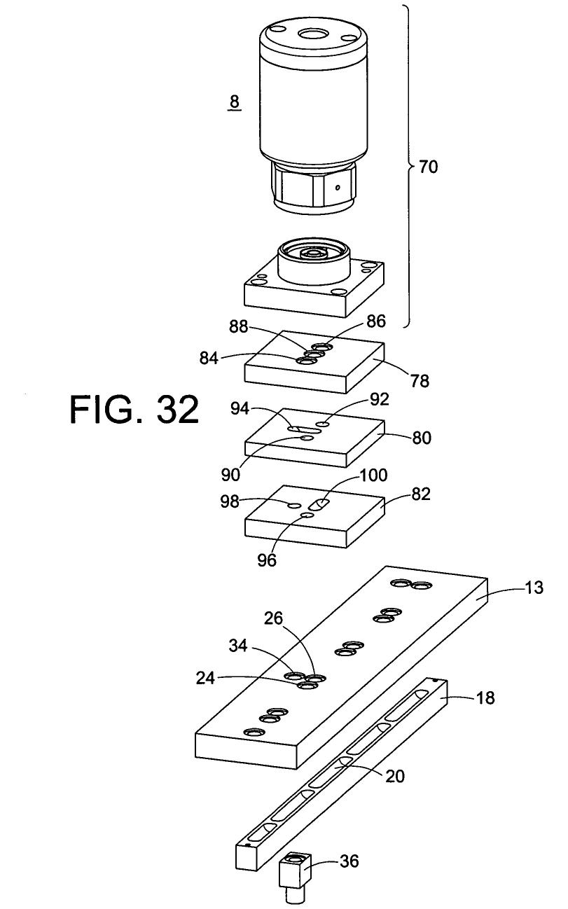

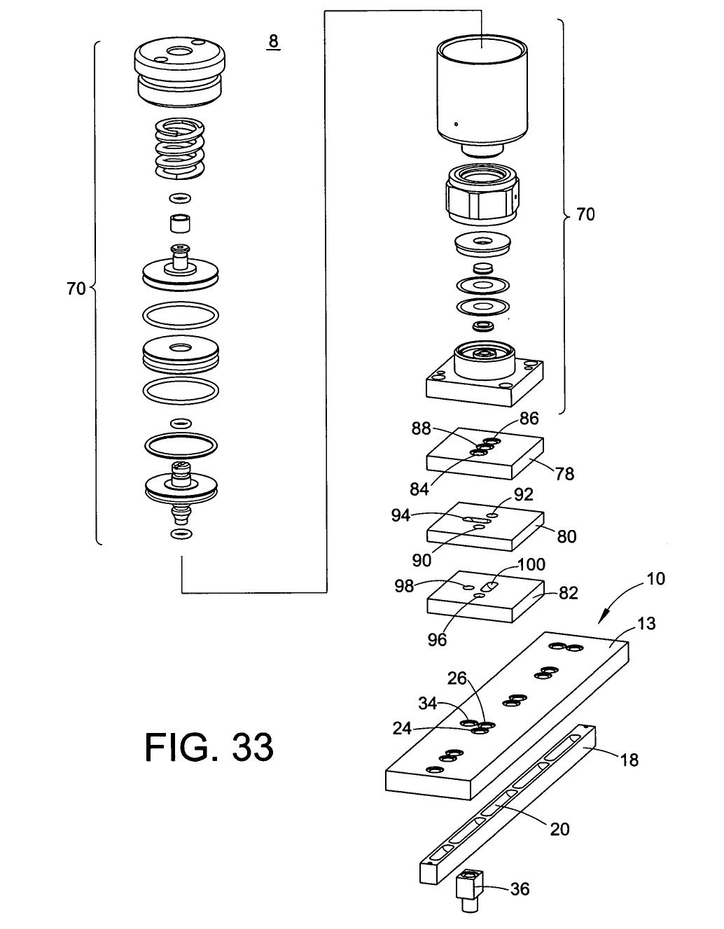

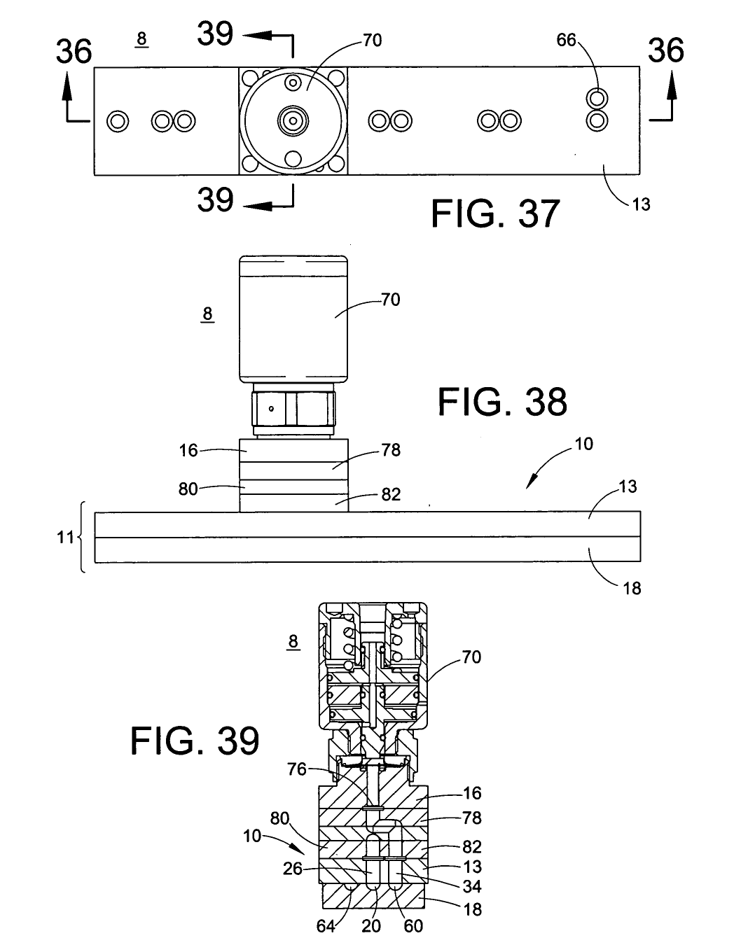

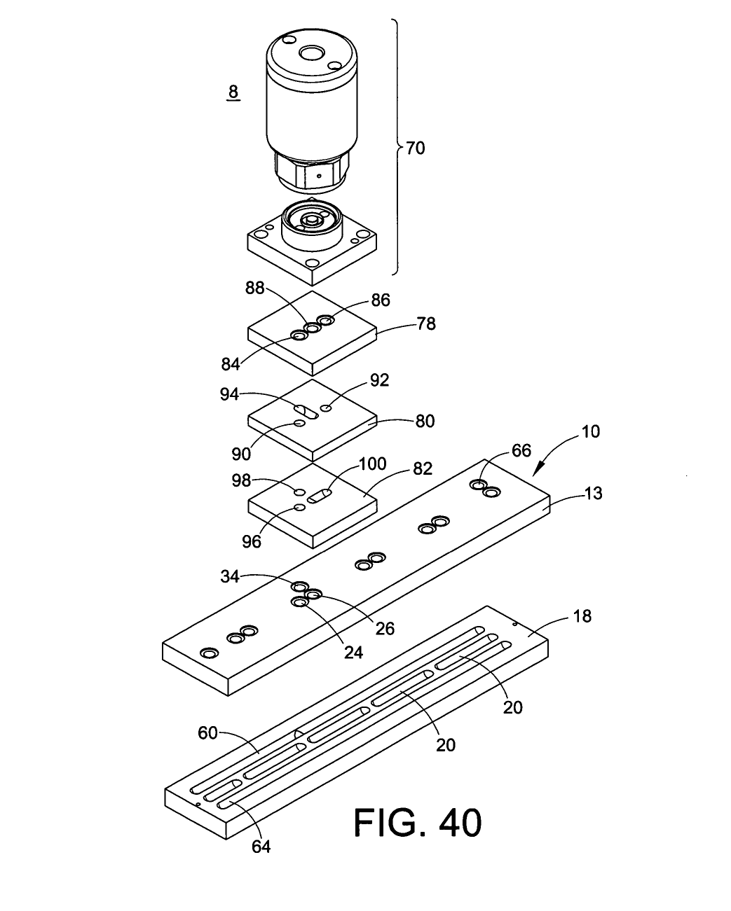

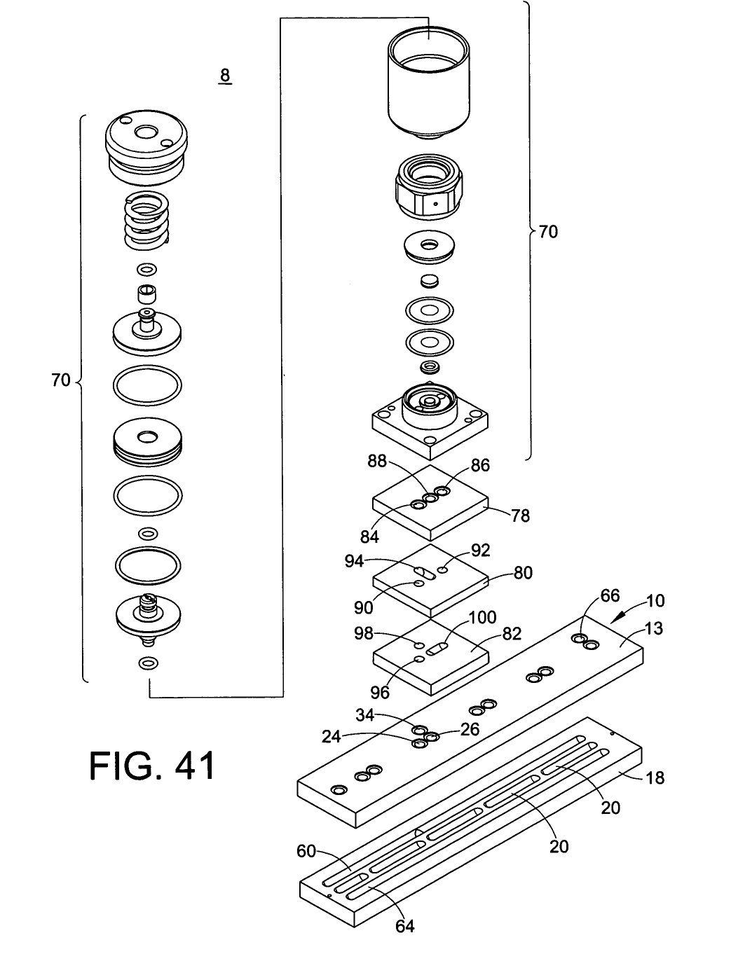

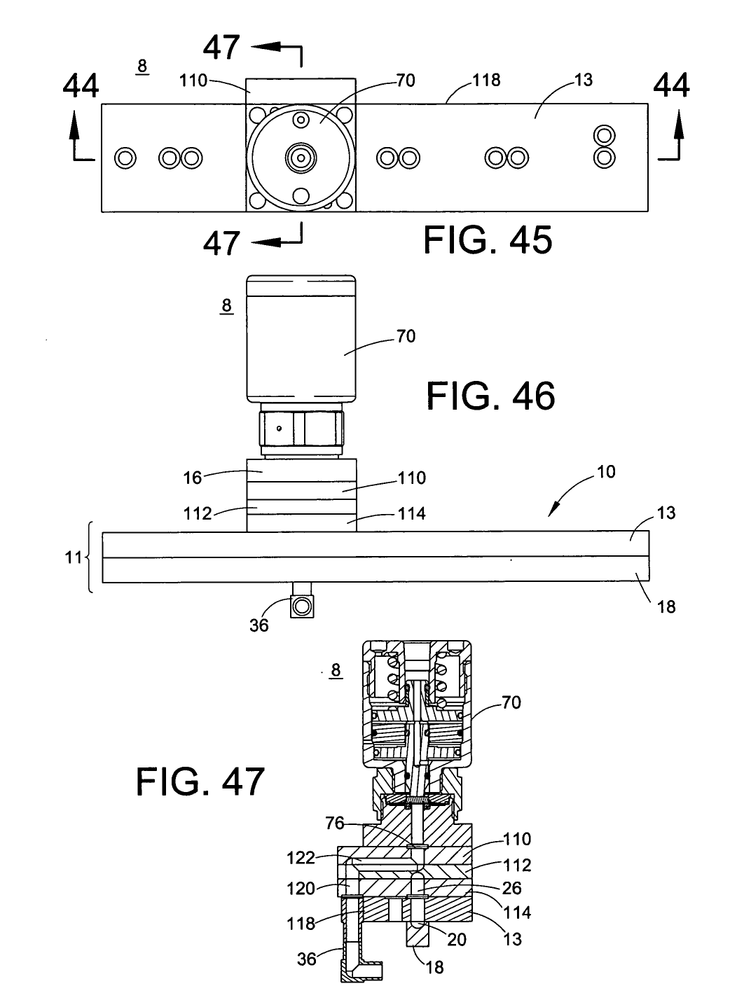

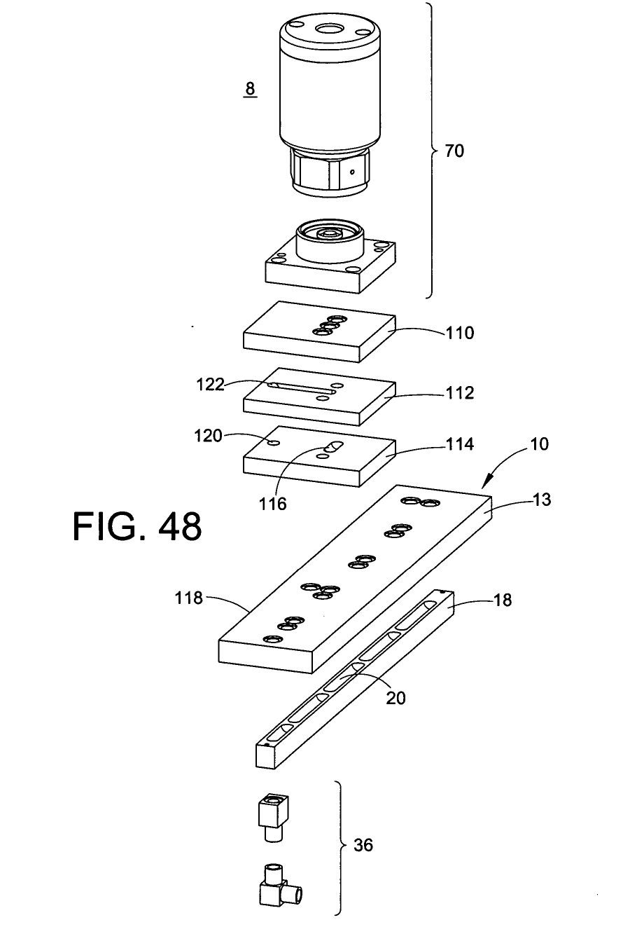

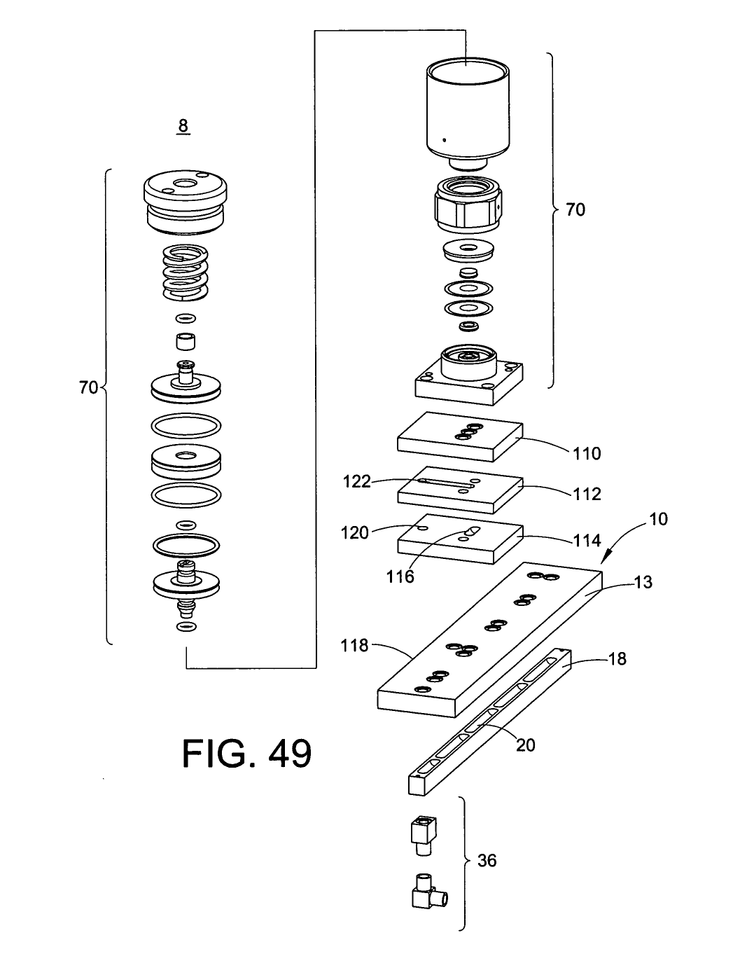

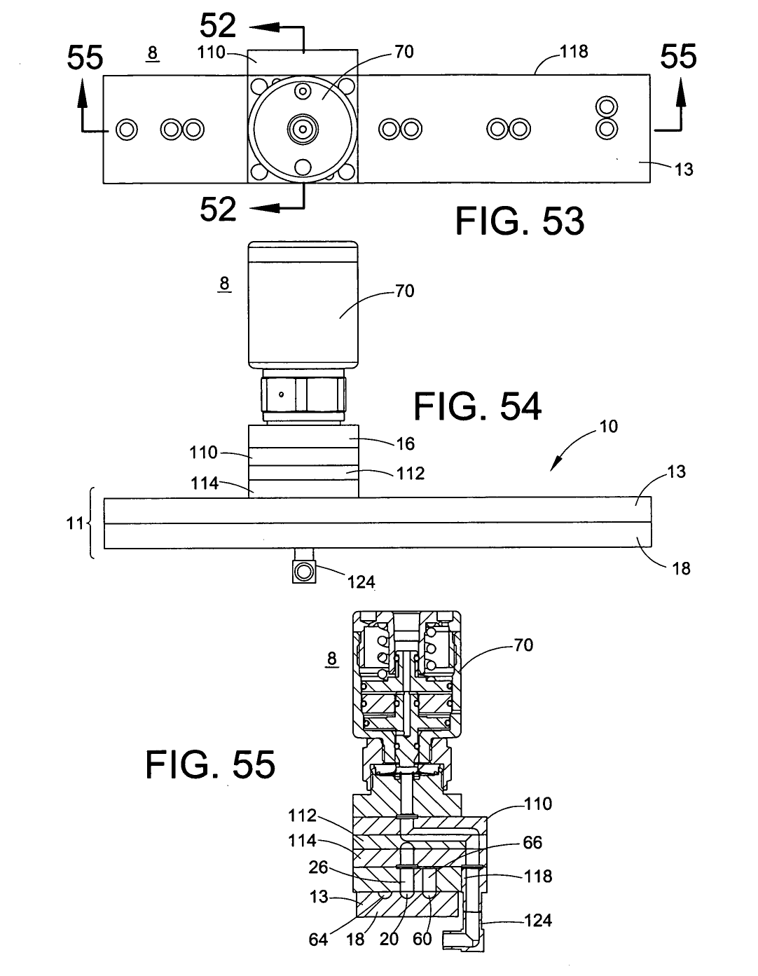

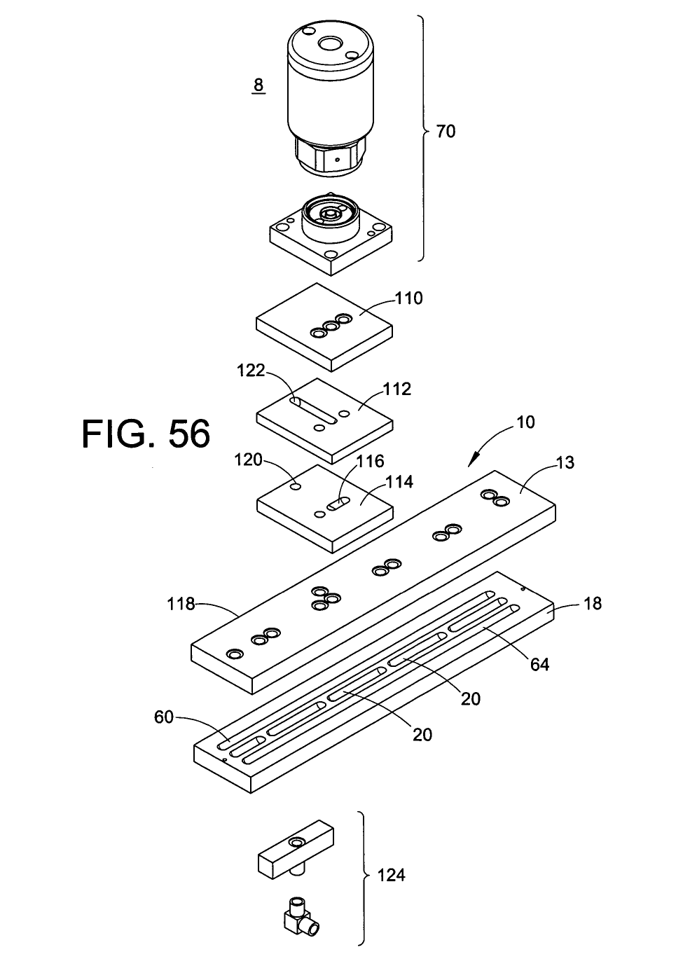

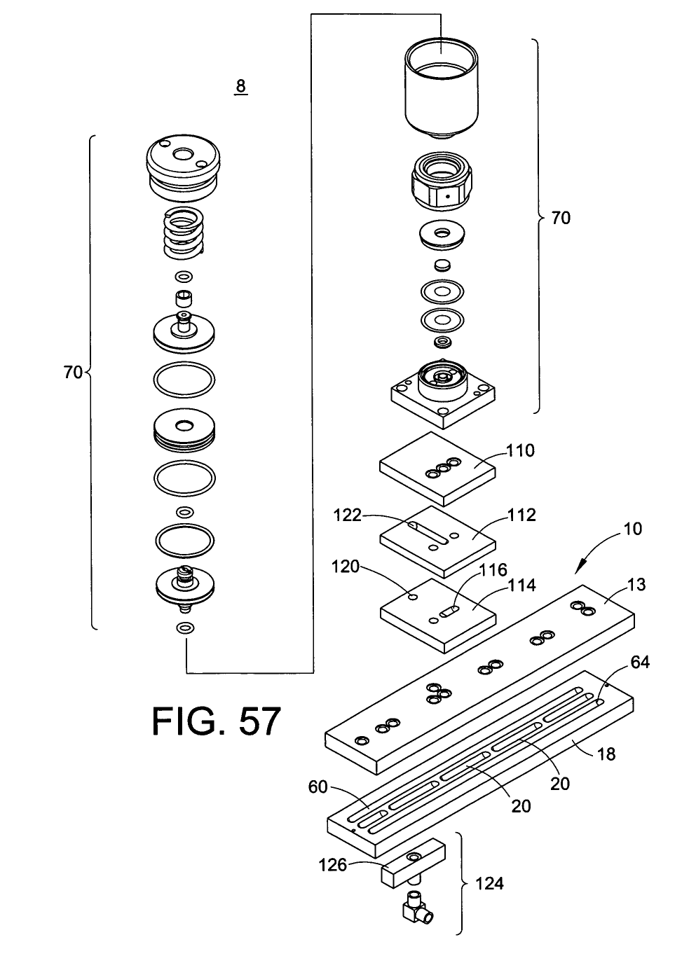

The embodiments shown in FIGS. 26-57 illustrate substrates 10 and adapters 78, 80, 82 that can be used for flow control devices that have three or more in-line ports rather than an offset port 32. In the flow control devises 14 previously discussed, flow is directed from the offset aperture 34 into the flow control device 14 through an offset port 32. The adapter plate can be positioned between a flow control device and a substrate to offset or laterally divert flow from an offset aperture in a substrate to an in-line port in the flow control device.

In the embodiments of FIGS. 26-33, a flow control device 70 includes three in-line ports—an inlet port 72, and outlet port 74, and a multi-use port 76. The multi-use port 76 may be used for purging or any other purpose desired. A substrate 10 is provided that may be the same as described in the first embodiment and illustrated in FIGS. 1-8. A series of adapter plates 78, 80, and 82 are positioned between the flow control device 70 and the substrate 10. The adaptor plates 78, 80, 82 serve to offset or laterally divert flow between the flow control device 70 and the substrate 10.

A top plate 78 serves to connect the three in-line ports 72, 74, and 76 with plates 80, 82. The top plate 78 includes three apertures 84, 86, 88 that coincide with the in-line ports 72, 74, and 76. A middle plate 80 serves to laterally offset flow directed to and from the multi-use port 76. The middle plate 80 includes three apertures 90, 92, 94. The first two apertures 90, 92 align with the inlet and outlet ports 72, 74 and do not alter flow directed to and from the inlet and outlet ports 72, 74. The third or offsetting aperture 94 is elongated in shape and laterally offsets flow directed to and from the multi-use port 76. This offsetting of the flow allows for an offset aperture 34 in the substrate 10 to be in fluid communication with the multi-use port 76 when the flow control device 70 is coupled to the substrate 10. The bottom adapter plate 82 also includes three apertures 96, 98, 100. First and second apertures 96, 98 are aligned with the inlet and multi-use ports 72, 76 and do not laterally alter or offset the flow of fluid. The third aperture 100 laterally offsets the flow directed to and from the output port 74. The flow is offset laterally such that the outlet aperture 26 in the substrate 10 is in fluid communication with the outlet port 74 when the flow control device 70 is coupled to the substrate 10.

The inlet and outlet ports 72, 74 are in fluid communication with the flow paths 20 located in a flow block 18 via the inlet and outlet apertures 24, 26. The multi-use port 76 is in fluid communication with a connector 36 that is coupled to the substrate 10 via the offset port 34.

In the example illustrated by FIGS. 26-33, the offsetting apertures 94, 100 are described and illustrated as elongated apertures. It should be understood that many methods of laterally offsetting flow directed to and from a flow control device port can be employed. Any additional methods that allow for offsetting of flow directed to and from a port in a flow control device can be used.

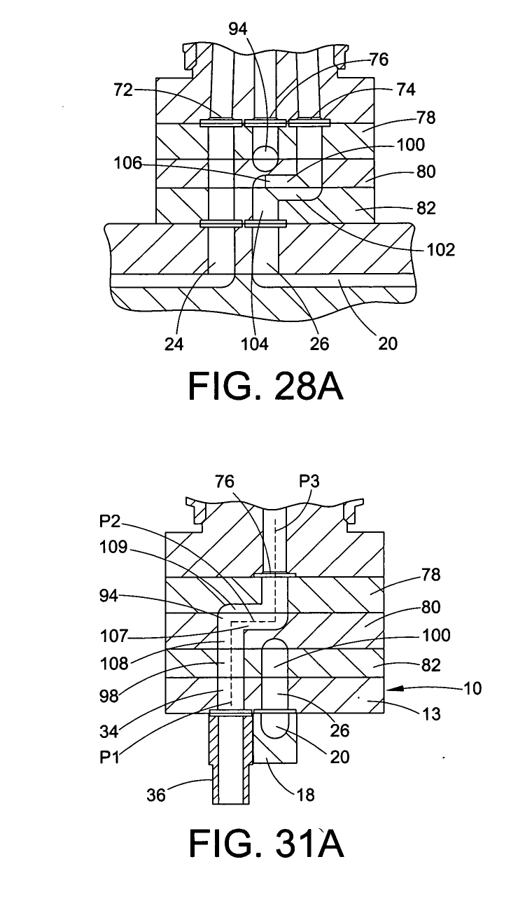

In the exemplary illustration, the offsetting apertures 94, 100 are formed such as to not interfere with offsetting apertures in adjacent adapters. Referring to FIGS. 28 and 31, an offsetting aperture 94 of the middle plate 80 and an offsetting aperture 100 of the bottom plate 82 can overlap in a vertical plane (see FIGS. 28 and 31) due to structure that allows for the lateral offsetting of flow. In the exemplary illustration, that structure is the elongated nature of the apertures 94, 100. The apertures are formed in a way such that there is no fluid communication between these offsetting apertures 94, 100. For example, as is best seen in FIG. 28, the offsetting aperture 100 comprises a groove 102 that is formed in the bottom plate 82 that does not pass through the bottom plate 82 and a hole 104 that does pass through the bottom plate 82. The groove 102 in the bottom plate 82 can be matched by a groove 106 in the middle plate 80 so as to create a cross-sectional area that matches the cross-sectional area of other apertures in the adapter plates. As can best be seen in FIG. 31, the offset aperture 94 in the middle plate has a similar structure. The aperture 94 comprises a groove 107 formed in the middle plate 80 that does not pass through the middle plate 80 and a hole 108 that does pass though the middle plate 80. An additional groove 109 can be formed in the upper plate 78 to match the groove 107 in the middle plate 80. The grooves 102, 106, 107, 109 are the mechanism by which the flow is laterally offset; however, these grooves 102, 106, 107, 109 are designed to be shallow and not interfere with any other groove or aperture in adjacent plates.

It should be understood that when components are described as mounted or coupled, these descriptions include direct contact or coupling of components as well as indirect contact or coupling of components. For example, a flow control device 70 is considered mounted to or coupled with a substrate 10 when three adapter plates 78, 80, 82 are positioned between the components, as long as the position of the flow control device 70 is secured relative to the position of the substrate 10.

The top plate may alternatively be eliminated and the apertures 90, 92, 94 of the middle plate 80 may be in direct contact and directly connected to the three in-line ports 72, 74, 76.

The adapter plates 78, 80, 82 are shown as three individual components; however, the plates may be optionally formed as one component in a single mold or cast block. If the plates 78, 80, 82 are manufactured individually, they may be coupled together with any coupled method, including fasteners or diffusion bonding.

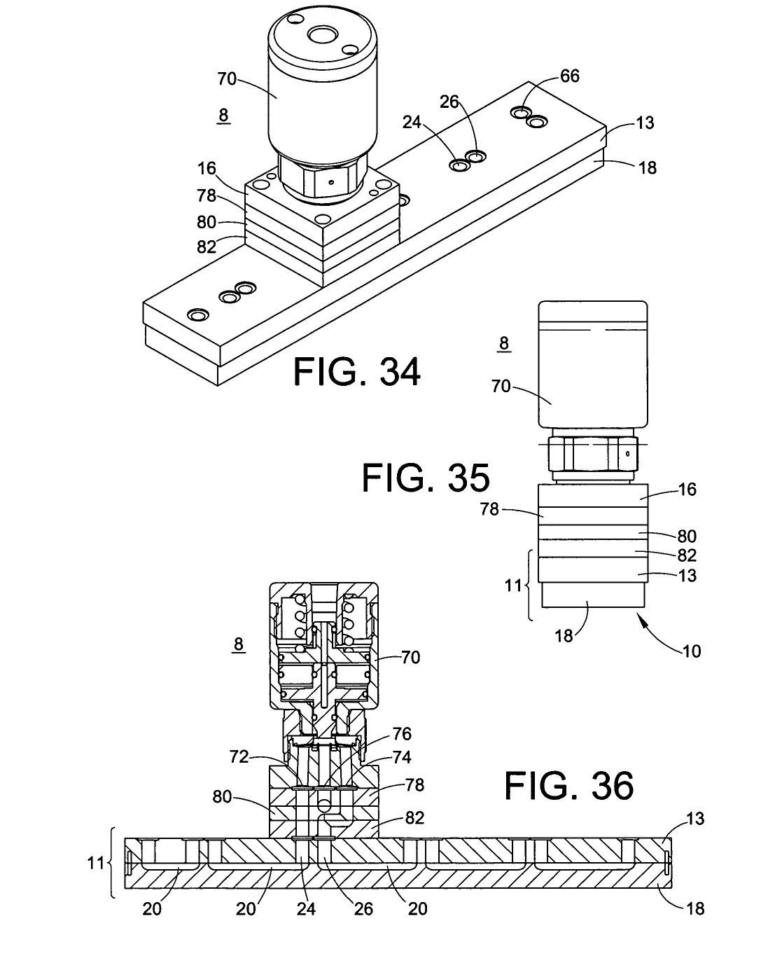

FIGS. 34-41 illustrate an embodiment similar to FIGS. 26-33. One distinction is that a flow block 18 illustrated by FIGS. 9-25 replaces the flow block illustrated by FIGS. 26-33. The adapter plates 78, 80, 82 laterally offset the flow directed to and from the multi-use port 76 and the outlet port 84 to place those ports in fluid communication with the offset aperture 34 and an outlet aperture 26 in the substrate 10. The adapter plates 78, 80, 82 place the inlet port 72 in fluid communication with the inlet aperture 24, but do not laterally offset flow directed between the inlet port 72 and the inlet aperture 24.

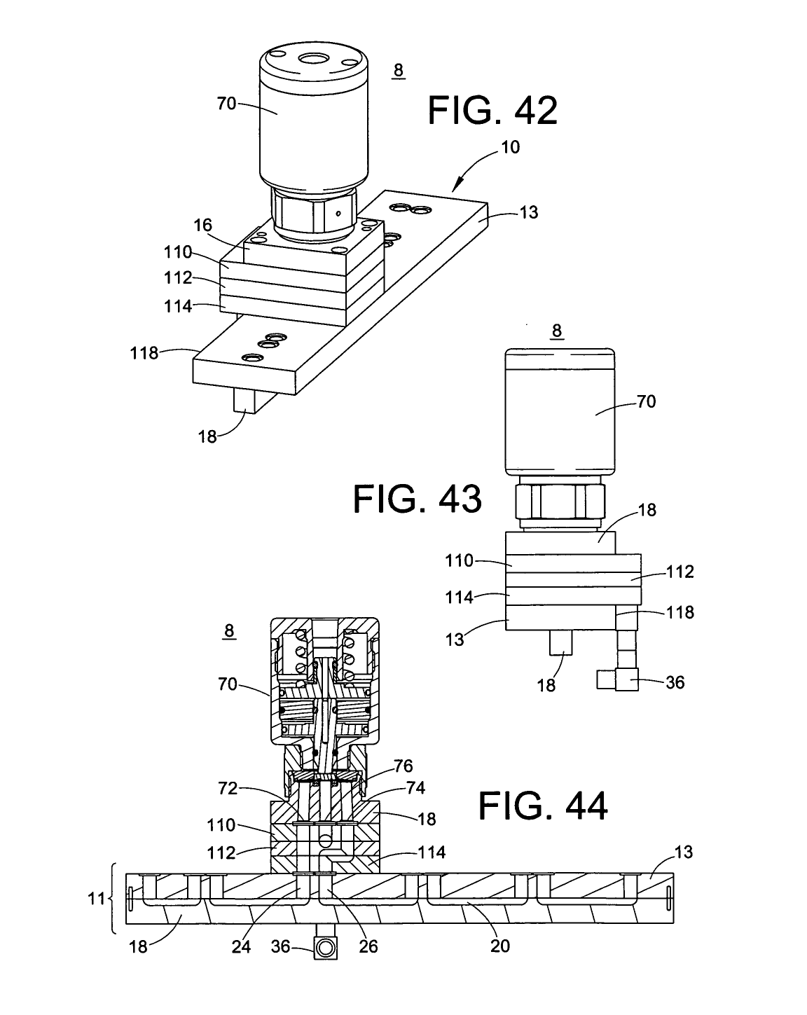

FIGS. 42-49 illustrate another embodiment of the invention. In this example, three adapter plates 110, 112, 114 are positioned between a flow control device 70 with three in-line ports 72, 74, 76 and a substrate 10. The adapter plates 110, 112, 114 laterally offset the flow directed between an outlet aperture 26 in the substrate 10 and the outlet port 74. An offset aperture 116 in the bottom plate 114 laterally offsets the flow directed to and from the output port 74. Flow directed to and from the multi-use port 76 is also laterally offset. When the plates 110, 112, 114 are positioned between the flow control device 70 and the substrate 10, the plates 110, 112, 114 extend beyond the side 118 of the substrate 10. This allows the adapter plates 110, 112, 114 to laterally offset the flow directed to and from the multi-use port 76 such that a connector 36 can be coupled directly to the bottom plate 114 and be in fluid communication with the multi-use port 76. The flow directed to and from the multi-use port 76 is laterally offset past the side 118 of the substrate 10 by an elongated aperture 122 located in the middle plate 112. The elongated aperture 122 aligns with the aperture 120 in the bottom plate 114 to place an adapter 36 in fluid communication with the multi-use port 76.

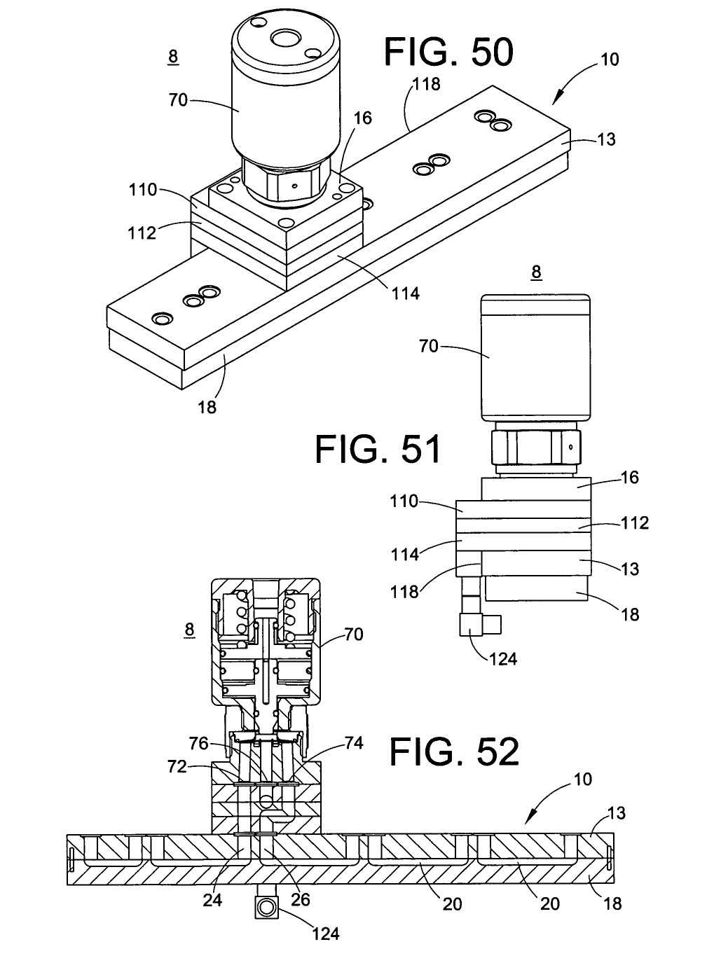

FIGS. 50-57 illustrate an embodiment similar to FIGS. 42-49 with the flow block 18 replaced by one of the flow blocks illustrated by FIGS. 9-25. The use of this flow block 18 allows for flexibility in adding additional flow control components to the substrate that may utilize the additional channels 64.

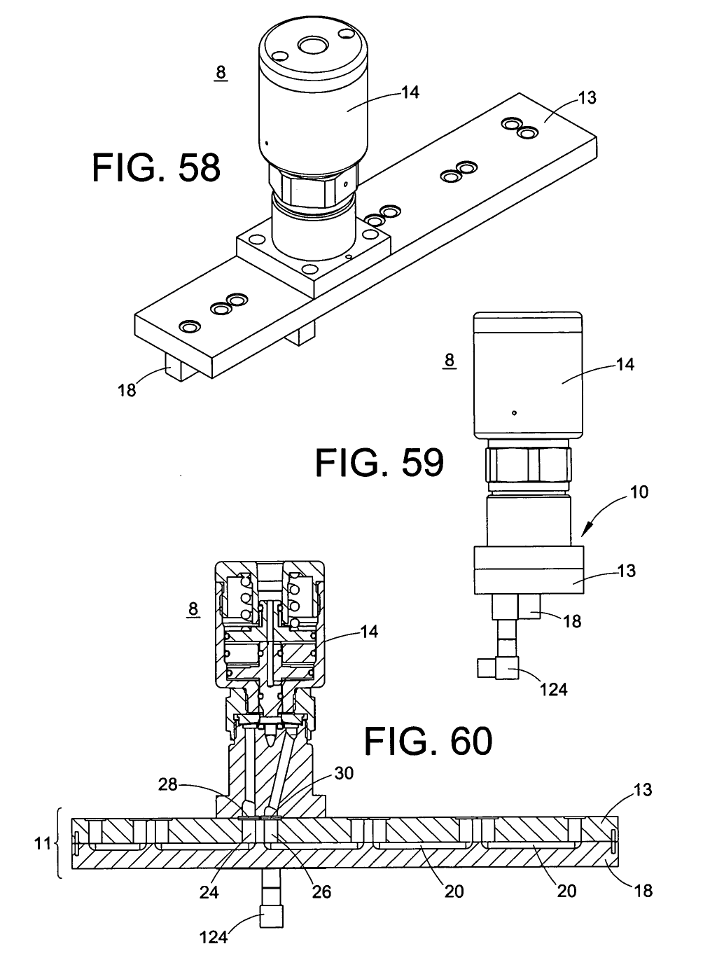

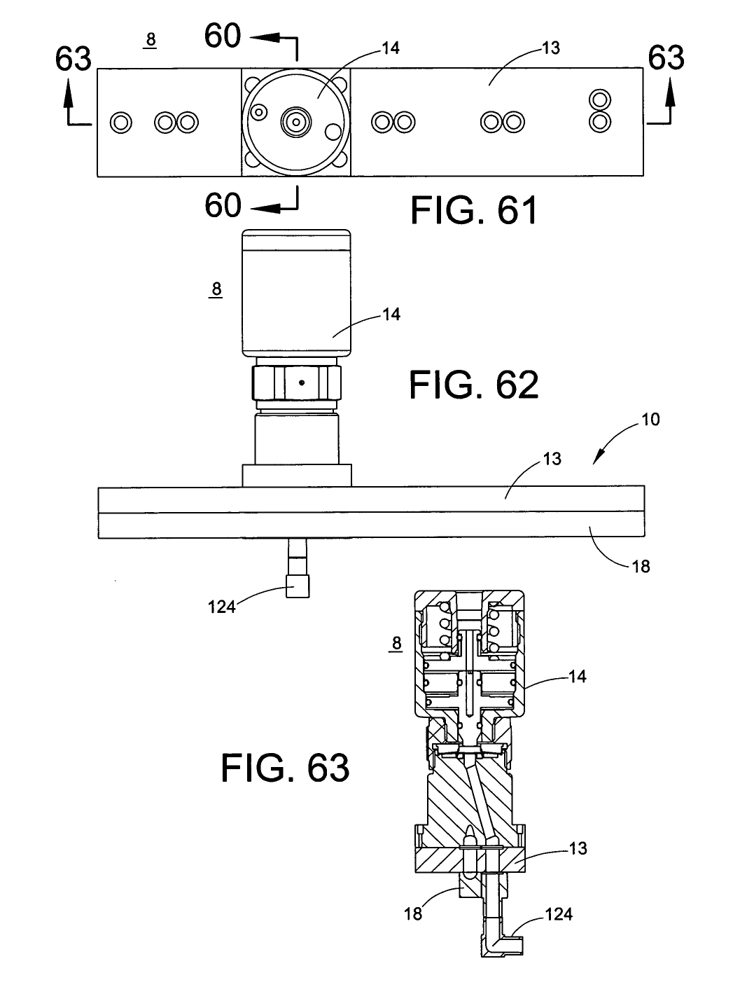

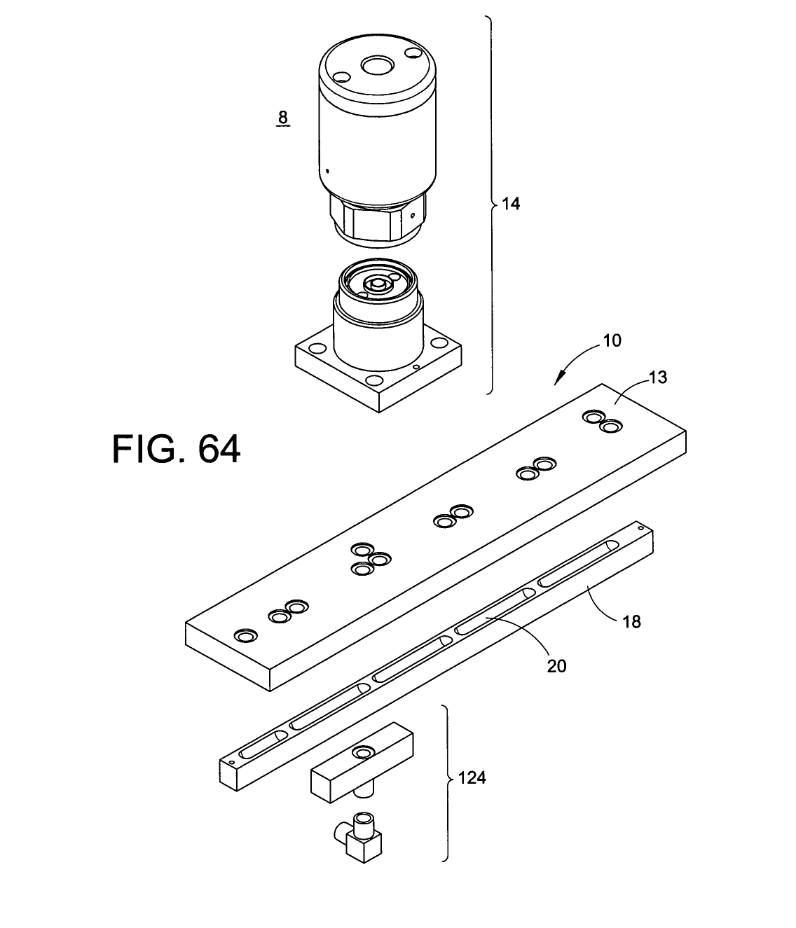

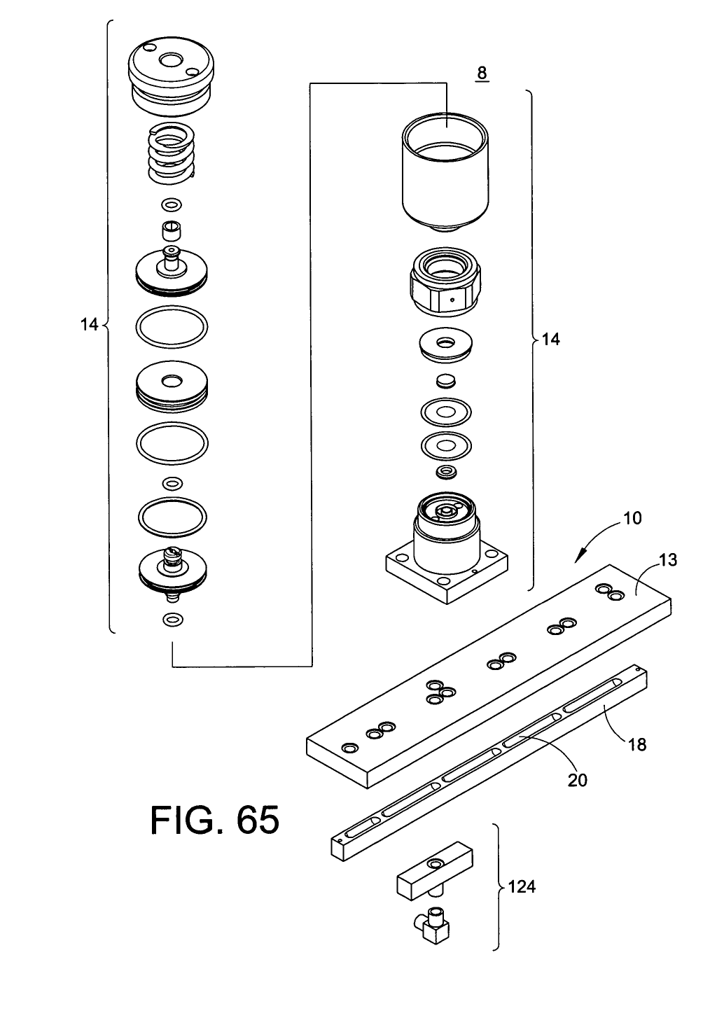

FIGS. 50-65 illustrate embodiments where an alternate connector 124 is used. The connector 124 has a large mounting flange surface for connecting the connector to the flow control system. This connector 124 provides for a larger contact surface 126 by which to couple the connector 124 to either the substrate 10 or bottom adapter 114.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

We claim:

1. A substrate for a modular fluid flow system, said substrate being adapted to support one or more surface mount components thereon, the substrate comprising:
a. a main body;
b. a plurality of in-line inlet and outlet apertures defined in the main body;
c. a plurality of flow passages defined in the main body that interconnect pairs of said in-line inlet and outlet passages;
d. an offset aperture defined in the main body that is positioned laterally with respect to the plurality of in-line inlet and outlet apertures;
e. an offset passage defined in the main body in fluid communication with the offset aperture, the offset passage being offset with respect to the respect to the flow passages.

2. The substrate of claim 1 wherein the main body comprises an interface plate with the inlet aperture, the outlet aperture, and the offset aperture defined therein and a flow block with the flow passages and the offset passages defined therein.

3. The substrate of claim 2 wherein the interface plate and the flow block are connected by diffusion bonding.

4. The substrate of claim 1 wherein a second offset aperture is defined in the main body and is in fluid communication with the offset passage.

5. The substrate of claim 1 wherein an offset aperture is defined in the main body for each inlet aperture.

6. The substrate of claim 1 wherein the inlet apertures are uniformly spaced.

7. The substrate of claim 1 wherein the offset aperture is a purge aperture.

8. A modular fluid system comprising:
a. a substrate including:
i) a plurality of in-line apertures;
ii) flow passages that interconnect pairs of said in-line apertures;
iii) an offset aperture that is positioned laterally with respect to the in-line apertures;
iv) an offset passage in fluid communication with the offset aperture and offset with respect to the respect to the flow passages;
b. a flow control device with an inlet port, an outlet port, and an offset port coupled to the substrate such that the inlet port is in fluid communication with a first of the in-line apertures, the outlet port is in fluid communication with a second of the in-line apertures, and the offset port is in fluid communication with the offset aperture.

9. The modular fluid system of claim 8 wherein the substrate comprises an interface plate with the inlet aperture, the outlet aperture, and the offset aperture defined therein and a flow block with the flow passages and the offset passages defined therein.

10. The modular fluid system of claim 8 wherein a second offset aperture is defined in the substrate and is in fluid communication with the offset passage.

11. The modular fluid system of claim 8 wherein the outlet apertures are uniformly spaced.

12. The modular fluid system of claim 8 wherein the offset aperture is a purge aperture.

13. The modular fluid system of claim 8 further comprising a connector coupled to the substrate such that the connector is in fluid communication with the offset port.

14. A method of routing fluid flow between one of three inline ports of a fluid control device and a substrate aperture that is offset with respect to the in-line ports, comprising:
a. directing fluid flow through the substrate aperture along a first flow path portion defined by the substrate aperture;
b. directing fluid flow along a second flow path portion that is generally transverse to the first flow path portion from the substrate aperture toward one of said in-line ports;
c. directing fluid flow along a third flow path portion that is generally transverse to the second flow path portion to said one of the in-line ports.

15. The method of claim 14 wherein said one of the in-line ports is a middle of the three in-line ports.

16. A fluid flow system comprising:
b. a substrate defining a plurality of in-line apertures such and a first offset aperture that is positioned laterally with respect to the in-line apertures;
b. a flow control device that includes inline inlet, outlet and offset ports;
c. an adapter member positioned between the substrate and the flow control device with apertures that provide fluid communication between thin inlet port and a first of the in-line apertures, fluid communication between the outlet port and a second of the in-line apertures, and fluid communication between the offset port and the first offset aperture.

17. The fluid flow system of claim 16 further comprising a connector coupled to the substrate such that the connector is in fluid communication with the offset port.

18. The fluid flow system of claim 16 further comprising a flow block, the flow block defining a flow path that connects two or more of the in-line apertures.

19. The fluid flow system of claim 16 wherein a channel defined in the substrate is in fluid communication with the first offset aperture.

20. The fluid flow system of claim 19 wherein the substrate defines a second aperture;
wherein the second aperture is in fluid communication with the channel.

21. The fluid flow system of claim 16 wherein the offset port is a purge port.
